(19) United States
(12) Patent Application Publication
(10) Pub. No.: US 2008/0065522 A1
(43) Pub. Date: Mar. 13, 2008

(54) LOW VOLATILITY ASSET ALLOCATION STRATEGY FOR INCOME AND METHOD

(75) Inventor: Keith B. Diffenderffer, Chula Vista, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Keith Bayley Diffenderffer, Chula Vista, CA (US)

(21) Appl. No.: 11/932,466

(22) Filed: Oct. 31, 2007

Related U.S. Application Data
(63) Continuation-in-part of application No. 11/535,650, filed on Sep. 27, 2006.
(63) Continuation-in-part of application No. 11/679,144, filed on Feb. 26, 2007.
(63) Continuation-in-part of application No. 11/833,411, filed on Aug. 3, 2007.
(60) Provisional application No. 60/596,489, filed on Sep. 28, 2005.
(60) Provisional application No. 60/806,814, filed on Jul. 10, 2006.

(51) Int. Cl. G06Q 40/00

(52) U.S. Cl. 705/36 R

(57) ABSTRACT

An income-producing vehicle may provide a low-volatility asset allocation strategy for an individual retirement investor by basing retirement income on multiple factors, rather than merely yield or earned income. In one embodiment, the vehicle is a portion of a retirement portfolio while additional vehicles, such as fixed and variable annuities and high distribution closed end funds, provide additional layers of consistent distributions. In another embodiment, the Defined Income Fund does not have the inflation adjustment limitations of immediate annuities, the prohibitive high costs and liquidity limitations of variable annuities, or the significant market risk of high distribution closed end funds. The vehicle may combine the risk and volatility control aspects of Modern Portfolio Theory (diversification, non-correlation and standard deviation) with a fixed percentage rate distribution schedule using funds as the core investment vehicle.

### RELATED APPLICATIONS

This application is a continuation-in-part of application Ser. No. 11/535,650, entitled “Multiple Fixed Rate Distribution Schedules from a Single Investment Strategy Model,” which was filed on Sep. 27, 2006, which claims the benefit of provisional Application No. 60/596,489, filed Sep. 29, 2005, application Ser. No. 11/679,144, entitled “Defined Fixed Percentage Rate Distribution Schedule for Open End Mutual Funds,” which was filed on Feb. 26, 2007, which claims the benefit of provisional Application No. 60/806,814, filed Jul. 10, 2006, and application Ser. No. 11/833,411, which was filed on Aug. 3, 2007, entitled “Multiple Fund Structure Mutual Funds Based on a Matrix Design Created By the Intersection of Multiple Risk/Reward Investment Strategy Models and Multiple Fixed Percentage Rate Distribution Schedules for Investment Funds,” all of the foregoing applications, the entire contents of which are expressly incorporated by reference herein.

### FIELD OF THE INVENTION

This patent relates to the field of finance and investment, and more particularly, to a method for generating retirement income, or any long-duration income stream, based on an investment fund vehicle employing Modern Portfolio Theory principals, a fixed percentage distribution, multiple fixed percentage distributions that are assigned to a single investment strategic model, and an investment strategic model/fixed percentage distribution matrix.

### BACKGROUND

Developed as an accumulation vehicle, managers have struggled to adapt investment funds as an investment vehicle for controlled distribution in retirement income portfolios. Although some investment funds have developed a fixed income scheme, their primary use in a retirement portfolio remains asset accumulation. In a typical scenario, high yield and senior loan markets excepted, a vast majority of fixed income distributions from funds are reinvested.

Retirement income portfolios require the simultaneous fulfillment of two goals: immediate distributions for an indefinite time period and distribution growth to adjust for inflation. Fixed income investments may provide immediate distributions, however, they do not offer income growth. In fact, any long-term retirement income strategy dependent primarily on fixed income investments is not likely to succeed. With retirement periods approaching twenty-five years and greater, distribution growth cannot be ignored. For example, a fixed income vehicle such as U.S. government bonds has a historical, 2.5% average annual real return. Therefore, any distributions greater than 2.5% would likely not provide satisfactory, long-term income for a portfolio owner.

Historical data also indicates that during a cycle of rising interest rates, real returns are likely to fall below the historical real return rate. For example, a 50-50 mix of 10-year Treasury Bonds and Aaa Corporate Bonds earned annualized real returns of 0% for the 51 years ending in 1984, a period of rising interest rates. Similar data for bonds and bond funds indicate that these fixed-income vehicles are not suitable for most long-term retirement portfolios. Starting with the 1940-1950 ten year timeframe, there were 24 consecutive ten year periods where U.S. Government Bonds offered an average annual nominal (not adjusted for inflation) total return of less than 3%. Further, the declining interest rate cycle that began in 1981 may continue. Unfortunately for current retirees, the last twenty-five year period reflects the best period in the history of the bond market and any retirement income portfolios built upon data from this period is unlikely to maintain its integrity.

An alternative to the fixed income funds described above may be accumulation funds. For example, equity mutual funds, with an average historical 6.5% real return, have been the foundation of the investment fund industry from its inception. Despite the effects of inflation and interest rates, equity fund returns have been stable. During the 24 consecutive ten year periods where bonds returned less than 3% per year, the S&P 500 average ten year annual return was 13.76%. During the twenty-five year period (1980-2005) that the U.S. Long Government bond had an average 11.03% annual nominal total return, the S&P 500 total return was 12.29%. Accumulation-oriented investors have made equity funds the foundation of retirement portfolios. However, while the average annual return on equity funds is much higher than fixed income investments, these funds suffer extreme variability in immediate returns as well as the potential for dramatic loss in any given year. Therefore, significant equity exposure may present disadvantages for retirees.

Another alternative combines the return potential of equity mutual finds with the downside resistance of fixed income funds. For example, a fund with a ratio of 60% equity stocks to 40% bonds and cash is a common approach to retirement portfolios (hereinafter a “60/40 portfolio”). Often, a 60/40 portfolio is composed of 40% U.S. large stock, 20% U.S. small stock, 30% bonds, and 10% cash. However, historical data for 60/40 portfolios indicates that, in an 81-year period, typical portfolios had a negative return in 18 of those years, or 22% of the total time period. In fact, the average positive annual return was 15.7% and the average negative annual return was −8.3%. Historical data further indicates that the worst one-year return among U.S. large stock was −43.3% and among U.S. small stock was −58%, while the typical 60/40 portfolio lost −27.9% in its worst year. While the 60/40 portfolio may present less risk to the retiree than the equity solution alone, its volatility makes it unsuitable as a foundation for long-duration income stream.

The performance of typical retirement portfolios also suffers from current investment entity distribution regulations. To maintain “pass through” tax status under the Internal Revenue Service code and §§19(a) and 19(b) of The Investment Company Act of 1940 (hereinafter, “the 1940 rules”), a qualifying investment entity must distribute 90% of earned income (interest, dividends, short- and long-term capital gains) on all annual basis. Pass-through taxation allows the income or loss generated by the investment entity to be reflected on the personal income tax return of the entity owners. This special tax status eliminates the possibility of double taxation, as the accumulated assets, and therefore the tax liability for those assets, essentially “passes through” the investment entity. However, because investment funds are generally considered accumulation vehicles, investors typically reinvest the distributed income, resulting in further income tax liability for the entity. With appropriate disclosure to the Securities and Exchange Commission (SEC), an investment entity may receive returned capital from an investor. However, regulatory hurdles associated with the disclosure make this method of cash flow distribution burdensome for the entity. While derivative strategies (e.g., closed end equity fund offerings specializing in dividend harvesting and call writing strategies) typically fabricate synthetic yields of 8-10% for the portfolio, the viability of these funds during turbulent market cycles is questionable. Therefore, neither returned capital nor derivative strategies provide a complete solution for retirement portfolios.

Currently, investment fund companies focus their retirement portfolio efforts within the framework described above. To overcome the described shortcomings, the companies have exerted time and resources to explain and implement, with their financial advisors, the complicated procedures for profitable use of the various retirement investment vehicles. For example, fund companies are experiencing success with “Lifestyle Funds” that target investors' tolerance for risk, and “Target Date Funds” that automatically re-allocate to become incrementally more conservative as an investor reaches a target retirement date. However, these funds still focus on performance rather than preservation of capital and are, essentially, accumulation-oriented. Risk and portfolio modeling tools may enable advisors and investors to select an appropriate portfolio and determine an annual retirement withdrawal amount with a calculated probability of capital preservation. However, the timing of the distributions during retirement is still determined by the advisor or investor. With retirement periods approaching forty years or more, improper timing of retirement asset withdrawal may have dire consequences for capital preservation.

### BRIEF DESCRIPTION OF THE DRAWINGS

FIG. 1 is a graph depicting annual returns on a plurality of strategic models;

FIG. 2 is a graph depicting 6% withdrawals over time from each of a plurality of strategic models;

FIG. 3 is an exemplary illustration of a computer network;

FIG. 4 is an illustration of a computing device;

FIG. 5 is one example of a method for generating retirement income using a Defined Income Fund; and

FIG. 6 is one example of a Defined Income Fund Matrix used to choose a Defined Income Fund.

### DETAILED DESCRIPTION OF THE INVENTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent that would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

A Defined Income Fund investment vehicle may use investment funds to provide a consistent, inflation-adjusted retirement income while preserving investment principal. An investment fund may include a Separately Managed Account, an annuity, a unit trust, an ETF portfolio, a mutual fund, or any other type of investment vehicle that is composed of other investment vehicles. The Defined Income Fund may satisfy the following conditions: it may be a perpetual offering that will be profitable in both good and bad market conditions, it may be transparent and easy to understand, it may be liquid from day-to-day, it may be low cost, it may benefit an investor's time in the market rather than the investor's timing in the market, and it may be optimized for volatility control rather than out-performing other investment funds. Generally, volatility is a measurement of a security's market price fluctuation and is a representation of that security's risk to an investor: the higher the volatility, the higher the risk. It is commonly expressed as the standard deviation of the security's return around an average (e.g., the periodic standard deviation of a security's rate of return).

Retirement planning may involve a plurality of planning periods during which investment strategy differs. For example, retirement planning may include an accumulation period and a distribution period. During the accumulation period, out-performance may be more important than volatility control as dollar cost averaging may transform volatility into a risk reduction and performance benefit. However, during the distribution period, a single year of negative performance may have drastic consequences. Referring to Table 1, a 10% loss may be recovered over a three-year time period in an accumulation period portfolio that averages a 3.6% annual return during the recovery period. In a distribution period portfolio, a 10% loss in a single year would require an 11.5% annualized return over the next three years to recover. A 60/40 portfolio, as previously described, may experience negative one-year returns 22% of the time, an average annual loss may be −8.3% and a highest one-year loss of −27.9%. If one out of every five years of a portfolio lifespan is negative (i.e., 22% of the time), the portfolio would have to perform better than its 15.7% average return in the next four consecutive years to recover such losses. To avoid these negative effects, a distribution period portfolio may be designed to include a lower level of volatility than the potential for single-year losses of 27.9% to take advantage of equity market returns.

The expected return and volatility of both an accumulation period portfolio and a distribution period portfolio may be determined by accounting for Modern Portfolio Theory factors including diversification, correlation of returns, and standard deviation. As first explained in “Portfolio Selection” by Harry Markowitz in The Journal of Finance (Vol. 7, No. 1, March 1952, pp. 77-91) and as expanded to include Modern Portfolio Theory, such portfolio analysis may reward a patient, risk-oriented investor, but will always under-perform an aggressive investor during a bull market. However, retirement portfolios may benefit most from controlling volatility and focusing on total return and a rational distribution mechanism. Multi-asset portfolios consisting of seven different asset classes (US Large Equity, US Small Equity, Non-US Equity, US Intermediate Bonds, Cash, REITS, and Commodities) may demonstrate high total returns, low standard deviations, and low aggregate correlation. Reductions in correlation and standard deviation of return may result in lower worst-case portfolio losses.

TABLE 1
Needed Average Annual Return to Restore Original Portfolio Balance
$500,000 initial balance, First Year End-of-Year Withdrawal of 5%
of initial balance, 3% annual increase of withdrawal

| Portfolio | Within | Within | Within | Within | Within |
|---|---|---|---|---|---|
| Loss | 1 Year | 2 Years | 3 Years | 4 Years | 5 Years |
| | Retirement Distribution Period Portfolio | | | | |
| −2% | 13.1% | 9.2% | 8.0% | 7.5% | 7.2% |
| −5% | 16.8% | 11.1% | 9.3% | 8.4% | 8.0% |
| −10% | 23.7% | 14.4% | 11.5% | 10.1% | 9.4% |
| −15% | 31.4% | 18.0% | 13.9% | 12.0% | 10.9% |
| −20% | 40.2% | 22.0% | 16.5% | 14.0% | 12.5% |
| −25% | 50.2% | 26.4% | 19.4% | 16.1% | 14.3% |
| −30% | 61.8% | 31.3% | 22.6% | 18.5% | 16.2% |
| −35% | 75.3% | 36.9% | 26.1% | 21.2% | 18.4% |
| | Accumulation Period Portfolio | | | | |
| −2% | 2.0% | 1.0% | 0.7% | 0.5% | 0.4% |
| −5% | 5.3% | 2.6% | 1.7% | 1.3% | 1.0% |
| −10% | 11.1% | 5.4% | 3.6% | 2.7% | 2.1% |
| −15% | 17.6% | 8.5% | 5.6% | 4.1% | 3.3% |
| −20% | 25.0% | 11.8% | 7.7% | 5.7% | 4.6% |
| −25% | 33.3% | 15.5% | 10.1% | 7.5% | 5.9% |
| −30% | 42.9% | 19.5% | 12.6% | 9.3% | 7.4% |
| −35% | 53.8% | 24.0% | 15.4% | 11.4% | 9.0% |

One example of a stable, long-term investment strategy is a typical Charitable Endowment Fund. To maintain a tax-free status, a charitable endowment fund must distribute a minimum of 5% of its assets each year. As the goal of a charitable endowment fund is to maintain the fund in perpetuity, it must provide immediate cash flow while accumulating assets for inflation-adjusted, future distributions. One example of a successful charitable endowment fund is the Yale University Endowment Fund. Yale University follows a disciplined long-term basic distribution rate of 5% adjusted by a smoothing formula to reduce spending volatility. Assets of the Yale University Endowment Fund include six different asset classes that are regularly rebalanced to control risk: Domestic Equity, Fixed Income, Foreign Equity, Absolute Return, Private Equity, and Real Assets. Using this strategy, during one 22-year period, the Yale University Endowment Fund averaged a return of 16.1% a year while allocating less than 10% to fixed income investments. While the strategies employed by the Yale University Endowment Fund may not be possible for an individual investor, the endowment fund faces similar challenges, only on a much larger scale. For the individual investor, Exchange Trade Funds (ETF) may provide a partial alternative to many of the illiquid components employed by the Yale Endowment Fund.

A Defined Income Fund may be an income-producing vehicle that provides a low-volatility asset allocation strategy for an individual retirement investor by basing retirement income on multiple factors, rather than merely yield or earned income. In one embodiment, the Defined Income Fund is a portion of a retirement portfolio while additional vehicles, such as fixed and variable annuities and high distribution closed end funds, provide additional layers of consistent distributions. In another embodiment, the Defined Income Fund does not have the inflation adjustment limitations of immediate annuities, the prohibitive high costs and liquidity limitations of variable annuities, or the significant market risk of high distribution closed end funds.

As previously discussed, retirement income may require a focus on risk or volatility control, total return and rational distribution. While the Modern Portfolio Theory and Yale University Endowment Fund examples focus on risk and total return in multi-asset, mean variance, allocation modeled portfolios, these examples lack a rational distribution mechanism that is suitable for the individual investor. While typical distribution mechanisms are based solely on earned income or yield, as discussed above, poor market performance may render this mechanism unsatisfactory. Therefore, a more effective distribution mechanism may operate effectively in all market cycles as part of a daily liquid perpetual offering. For example, the distribution mechanism may be based on prospectus rules that are consistently applied to all models, as described below. The Defined Income Fund may transform the current investment fund model from an accumulation vehicle to a distribution vehicle for retirement income. In one embodiment, a Defined Income Fund may include multiple alternative asset classes that are not otherwise available to a typical long-duration investor, and may combine the risk and volatility control aspects of Modern Portfolio Theory (e.g., the Modern Portfolio Theory factors of diversification, correlation and standard deviation) with a fixed percentage rate distribution schedule using investment funds as the core investment vehicle.

Further, a Defined Income Fund may collect income from its equity and debt investments in the form of interest payments, dividends, rents, royalties, premiums, short term capital gains, long term capital gain and return of capital. Any of the embodiments described herein may be executed via many different types of investment vehicles to include individual actively managed portfolios, fund of funds, and index based exchange-traded funds (ETF) portfolios. For example, exposure to multiple asset classes rather than security selection may rationalize an indexed-based ETF platform. Distributions of income may then be made from a percentage of Per Share Net Asset Value (NAV) on a periodic schedule (e.g., monthly, quarterly, bi-annually, annually, etc.). For example, a fund with a 4% annual distribution may distribute 1% NAV quarterly, a fund with a 5% annual distribution may distribute 1.25% NAV quarterly, and a fund with a 6% annual distribution may distribute 1.5% NAV quarterly. A supplemental annual distribution may also be established to ensure compliance with the 1940 rules.

Further, the Defined Income Fund may include a variety of strategic models to suit investors' differing tolerances for risk and volatility. Each strategic model may have a unique collection of equity, fixed income, alternative asset, and other investments as well as different distribution schedules that may maintain the model's total return and volatility targets and remain sustainable in substantially all market cycles while maintaining a marketable yield for the investor. In use, an investor may select both the strategic model and distribution rate from a Distributed Income Fund Matrix to satisfy their retirement goals. Some examples of strategic models are income, balanced income, and equity income, each with unique asset allocation and selectable distribution rates. The models may include targets for both return and volatility, where volatility is a measure of the standard deviation from the total return target. In one embodiment, an income model includes a total return target of 6-8% and a volatility target of 4-6%, a balanced income model includes a total return target of 8-10% and a volatility target of 6-8%, and an equity income model includes a total return target of 10-12% and a volatility target of 8-10%. In another embodiment, a custom income model includes virtually any combination of assets that meets an investor's long-term income goals within return and volatility targets. Each strategic model may also be offered on a variety of bases, for example, a tax-advantaged model and a non-tax-advantaged model, and may be based on current or forecasted market conditions. Of course, many other models and many other values for return and volatility are possible.

In one embodiment, a fixed percentage rate distribution schedule may control retirement portfolio payments to an investor. In contrast to retirement portfolio distribution based on a fixed amount to be distributed periodically, a fixed percentage rate distribution may reduce or eliminate the risk that, over a long retirement, period the fixed amount distributions will liquidate the portfolio. Further, the fixed percentage rate distribution schedule may allow the investor greater ability to recover from difficult market conditions. Whether an investor begins at the top or bottom of a market cycle, the fixed percentage rate distribution schedule may remain constant and may provide a rational structure for long-term, retirement distributions. The fixed percentage rate distribution schedule may be fixed by prospectus and allow the distribution to fluctuate according to the value of the fund and, thus, according to market activity. For example, if the value of the fund declines, the value of the distribution may also decline and may prevent an implicit forced liquidation schedule in the event of a radical fund value decline.

Distributions under the fixed percentage rate distribution schedule may also be predicted, thus maintaining a coherent distribution structure. For example, shareholders may reference a daily net asset value (NAV) of the fund. The investor may calculate their distribution based on the ex-dividend date NAV (the date the fund trades without its dividend; to receive a declared dividend upon selling the fund, it must be sold on or after the ex-dividend day. The ex-date is the second business day before the date of record). Rather than focusing on 30 Day SEC Yield, as in typical fund trading, focus may be shifted to the dollar distribution amount and NAV, thus the fixed percentage rate distribution may increase investor understanding of fund performance and may allow investors to estimate future cash flows.

In another embodiment, multiple fixed percentage rate distributions may be assigned to a single investment strategic model (e.g., income model, balanced income model, equity income model, etc.). For example, an investment company may establish one or more investment strategic models, but assign a plurality of distribution schedules to the model if the model includes a sufficiently large number of investors. A sufficiently large number of investors may be any number whereby management of the model is a profitable venture for an investment company or other entity. A portfolio manager may then create a portfolio according to a strategic model and customize the distribution for each investor. Because retirement investors have diverse income needs and risk tolerances, each investor may require a different distribution rate. The possible distribution rates may each differ in the amount of distribution and the potential for growth. For example, a first investor may select an investment strategic model that satisfies his or her investment criteria and distributes 4% of NAV annually. A second investor may select the same investment strategic model, but with a 6% annual distribution of NAV. Therefore, using the same investment strategic model, the first investor may exchange a lower present income for a potentially higher future asset growth, while the second investor may exchange a higher present income for potentially lower future asset growth. Regardless of the investment strategic model and distribution rate chosen, if an actual total return rate of the model is higher than the fixed percentage rate distribution, asset growth may outpace the payout and the retirement period may be indefinite.

In a still further embodiment, a Defined Income Fund may be selected for a retirement portfolio based on an matrix intersection of an investment strategic model along a first axis with a fixed percentage rate distribution schedule along a second axis to determine a Defined Income Fund Matrix, shown in Table 2. Choosing a retirement portfolio based on this intersection may achieve a retirement income strategy that is not based on either a yield or earned income investment model. As previously described, yield or earned income-based distributions fail to adjust for portfolio growth and, thus, fail to adjust distributions for economic factors, such as inflation. However, the fixed percentage rate distribution will necessarily include portfolio growth and, so long as portfolio growth is equal to or greater than inflation or other economic factors, the distributions may account for those factors.

Because distributions may be an arbitrary percentage rate, and not reflective or conditioned on earned distributions, and because each fund has a large number of investors including a variety of distribution schedules, many alternative distribution schedules may be assigned to a single portfolio. Further, the large investor population and diverse distribution schedules may permit a variety of volatility/total return target models. Reflected in Table 2, a Defined Income Fund Matrix that presents the potential individual fund offerings may be created from the multiple fixed percentage rate distributions and multiple strategic models.

TABLE 2
Defined Income Fund Matrix

Strategic Model

| | | Balanced | Equity | Custom |
|---|---|---|---|---|
| | Income | Income | Income | Income |
| Fixed | 4% | 4% | 4% | 4% |
| Percentage | 5% | 5% | 5% | 5% |
| Distribution | . . . | . . . | . . . | . . . |
| Schedule | n% | n% | n% | n% |

The Defined Income Fund Matrix of Table 2 may be used by a retirement investor to improve investor distribution and increase the lifespan of Defined Income Fund retirement portfolios. This matrix structure may offer a coherent, easy to understand, rationale to the retirement income investor for transforming low-yield, risk-controlled asset allocation portfolios into cash flow producing, long-duration income vehicles. The Defined Income Fund Matrix may be applied to virtually any strategic model and virtually any fixed percentage rate distribution. Furthermore, if a retirement investor chooses a investment fund from a strategic model with an historical target total return that exceeds that of the distribution percentage rate, over time, the portfolio value and the distributions may grow despite short-term fluctuations. A longer retirement period may increase the value of the investment and, thus, the amount of the distribution.

Standard index data may be used to model performance of the strategic models utilizing a fixed percentage rate distribution. Tables 3, 4, and 5 depict the performance of an income, balanced income, and equity income portfolio strategy, respectively. Tables 3-5 include multiple, rolling ten-year periods for each type of portfolio. As illustrated, the final portfolio value and final annual distribution value have grown significantly. Even during bear market periods (2000 to 2002), the low interim value and low annual distribution value of each model may be consistent with the income, balanced income, and equity income strategies.

TABLE 3
Income Portfolio With 6% Fixed Percentage Rate Distribution
(12 Ten Year rolling returns 1985-2006; Subsequent cumulative returns to
June 2007. All periods start 12/31 and end 12/31)
Based on $100,000 investment with 1.5% Quarterly Withdrawal and Rebalancing

| | Final | Low | Avg. | Total | Final | Low |
|---|---|---|---|---|---|---|
| Period | Value | Value | Return | Withdrawal | Withdrawal | Withdrawal |
| 1985-1995 | $169,185 | $111,392 | 12.16% | $82,340 | $9,935 | $6,693 |
| 1986-1996 | 161,498 | 102,875 | 11.37% | 76,015 | 9,249 | 6,269 |
| 1987-1997 | 163,398 | 106,647 | 11.57% | 77,415 | 9,618 | 6,317 |
| 1988-1998 | 150,002 | 100,763 | 10.74% | 75,810 | 9,143 | 6,092 |
| 1989-1999 | 139,293 | 95,629 | 10.05% | 74,553 | 8,530 | 5,782 |
| 1990-2000 | 148,842 | 115,991 | 11.18% | 80,644 | 8,729 | 6,544 |
| 1991-2001 | 123,321 | 102,560 | 8.89% | 71,507 | 7,623 | 6,103 |
| 1992-2002 | 118,529 | 102,433 | 8.57% | 70,919 | 7,148 | 6,368 |
| 1993-2003 | 125,234 | 95,065 | 8.62% | 66,835 | 6,927 | 5,941 |
| 1994-2004 | 139,685 | 112,747 | 10.00% | 72,031 | 7,976 | 6,394 |
| 1995-2005 | 122,012 | 102,631 | 8.29% | 65,564 | 7,348 | 6,089 |
| 1996-2006 | 120,543 | 96,521 | 7.93% | 63,022 | 7,089 | 5,821 |
| 1997-June 2007 | 114,833 | 92,733 | 7.43% | 58,184 | 3,521* | 5,592 |
| 1998-June 2007 | 117,292 | 94,718 | 7.96% | 53,334 | 3,597* | 5,712 |
| 1999-June 2007 | 119,873 | 96,803 | 8.66% | 48,384 | 3,676* | 5,838 |
| 2000-June 2007 | 117,311 | 94,734 | 8.70% | 41,486 | 3,597* | 5,713 |
| 2001-June 2007 | 122,068 | 98,575 | 10.19% | 36,987 | 3,743* | 5,945 |
| 2002-June 2007 | 123,832 | 113,846 | 11.69% | 31,491 | 3,797* | 6,297 |

15% Citigroup Treasury/Gov't- Sponsored/Mortg
13% Citigroup Non-U.S. World Gov't Bonds
15% Lehman Intermediate Aggregate Bonds
15% Lehman U.S. Corporate High Yield Index
5% Goldman Sachs Commodity Index
5% Mount Lucas Managed Futures
3% D J Wilshire Small Cap Value Index
3% Russell Mid-Cap Value index
8% D J Wilshire Large Cap Value Index
2% MSCI EM (Emerging Mkt.)
6% MSCI World Value Index
10% FTSE NAREIT REIT: ALL
*Six Month Distribution

A strategic model portfolio may include a plurality of income portfolio funds. For example, one embodiment of an income portfolio may include a mixture of fixed income funds, equity, alternative asset, and other funds. The mixture as shown in the example of Table 3 includes: 15% Citigroup Treasury/Gov't-Sponsored/Mortgage, 15% Lehman Intermediate Aggregate Bonds, 15% Lehman U.S. Corporate High Yield Index, 13% Citigroup Non-U.S. World Gov't Bonds, 5% Mount Lucas Managed Futures, 5% Goldman Sachs Commodity Index, 8% DJ Wilshire Large Cap Value Index, 6% MSCI World Value Index, 3% DJ Wilshire Small Cap Value Index, 3% Russell Mid-Cap Value Index, 2% MSCI EM (Emerging Mkt.), and 10% FTSE NAREIT REIT:ALL. Of course, may other combinations and percentages of funds may constitute an income portfolio.

Likewise, a balanced income portfolio 500 may include a plurality of balanced income portfolio funds 505. For example, as shown in Table 4, one embodiment of a balanced income portfolio may include a 50% mixture of fixed income funds and a 50% distribution of equity funds and other funds. The mixture as shown in the example of Table 4 includes: 10% Citigroup Treasury/Gov't-Sponsored/Mortgage, 10% Citigroup Non-U.S. World Gov't Bonds, 10% Lehman Intermediate Aggregate Bonds, 10% Lehman U.S. Corporate High Yield Index, 5% Goldman Sachs Commodity Index, 5% Mount Lucas Managed Futures, 6% DJ Wilshire Small Cap Value Index, 8% Russell Mid-Cap Value index, 12% DJ Wilshire Large Cap Value Index, 4% MSCI EM (Emerging Mkt.), 10% MSCI World Value Index, and 10% FTSE NAREIT REIT:ALL. Of course, many other combinations and percentages of funds may constitute a balanced income portfolio.

TABLE 4
Balanced Income Portfolio With 6% Fixed Percentage Rate Distribution
(12 Ten Year rolling returns 1985-2006; Subsequent cumulative returns to
June 2007. All periods start 12/31 and end 12/31)
Based on $100,000 investment with 1.5% Quarterly Withdrawal and Rebalancing

| | Final | Low | Avg. | Total | Final | Low |
|---|---|---|---|---|---|---|
| Period | Value | Value | Return | Withdrawal | Withdrawal | Withdrawal |
| 1985-1995 | $183,061 | $111,826 | 13.08% | $84,502 | $10,281 | $6,519 |
| 1986-1996 | 177,391 | 102,572 | 12.43% | 79,790 | 10,054 | 6,396 |
| 1987-1997 | 184,620 | 109,808 | 12.94% | 82,310 | 10,757 | 6,453 |
| 1988-1998 | 164,154 | 100,260 | 11.70% | 79,103 | 10,022 | 6,161 |
| 1989-1999 | 151,361 | 92,430 | 10.80% | 76,231 | 9,176 | 5,680 |
| 1990-2000 | 167,689 | 117,494 | 12.53% | 86,119 | 9,789 | 6,636 |
| 1991-2001 | 135,497 | 103,220 | 10.00% | 76,036 | 8,387 | 6,122 |
| 1992-2002 | 124,671 | 104,784 | 9.36% | 75,437 | 7,705 | 6,425 |
| 1993-2003 | 134,178 | 95,160 | 9.43% | 69,882 | 7,208 | 5,969 |
| 1994-2004 | 152,623 | 114,074 | 11.04% | 75,726 | 8,562 | 6,406 |
| 1995-2005 | 134,289 | 104,299 | 9.35% | 68,731 | 7,964 | 6,142 |
| 1996-2006 | 133,590 | 96,250 | 8.98% | 65,517 | 7,758 | 5,948 |
| 1997-June 2007 | 125,771 | 90,162 | 8.31% | 59,370 | 3,823* | 5,572 |
| 1998-June 2007 | 128,817 | 92,346 | 9.03% | 54,702 | 3,916* | 5,879 |
| 1999-June 2007 | 128,794 | 92,329 | 9.50% | 48,630 | 3,915* | 5,878 |
| 2000-June 2007 | 125,775 | 90,165 | 9.66% | 41,653 | 3,823* | 5,572 |
| 2001-June 2007 | 132,480 | 94,973 | 11.68% | 37,684 | 4,027* | 5,869 |
| 2002-June 2007 | 139,494 | 118,511 | 14.69% | 33,498 | 4,240* | 6,366 |

10% Citigroup Treasury/Gov't- Sponsored/Mortgag
10% Citigroup Non-U.S. World Gov't Bonds
10% Lehman Intermediate Aggregate Bonds
10% Lehman U.S. Corporate High Yield Index
5% Goldman Sachs Commodity Index
5% Mount Lucas Managed Futures
6% D J Wilshire Small Cap Value Index
8% Russell Mid-Cap Value index
12% D J Wilshire Large Cap Value Index
4% MSCI EM (Emerging Mkt.)
10% MSCI World Value Index
10% FTSE NAREIT REIT: ALL
*Six Month Distribution

Further, an equity income portfolio 600 may include a plurality of equity income portfolio funds 605. For example, as illustrated in Table 5, one embodiment of an equity income portfolio 600 may include a mixture of fixed income funds, equity funds, and other funds. The mixture as shown in Table 5 includes: 6% Citigroup Treasury/Gov't-Sponsored/Mortgage, 7% Citigroup Non-U.S. World Gov't Bonds, 6% Lehman Intermediate Aggregate Bonds, 7% Lehman U.S. Corporate High Yield Index, 5% Goldman Sachs Commodity Index, 5% Mount Lucas Managed Futures, 8% DJ Wilshire Small Cap Value Index, 10% Russell Mid-Cap Value index, 15% DJ Wilshire Large Cap Value Index, 6% MSCI EM (Emerging Mkt.), 15% MSCI World Value Index, and 10% FTSE NAREIT REIT:ALL. Of course many other possible combinations and percentages of funds may contribute to an equity income portfolio.

TABLE 5
Equity Income Portfolio With 6% Fixed Percentage Rate Distribution
(12 Ten Year rolling returns 1985-2006; Subsequent cumulative returns to
June 2007. All periods start 12/31 and end 12/31)
Based on $100,000 investment with 1.5% Quarterly Withdrawal and Rebalancing

| | Final | Low | Avg, | Total | Final | Low |
|---|---|---|---|---|---|---|
| Period | Value | Value | Return | Withdrawl | Withdrawal | Withdrawal |
| 1985-1995 | $194,579 | $112,512 | 13.81% | $87,680 | $10,857 | $6,557 |
| 1986-1996 | 189,990 | 102,344 | 13.22% | 82,794 | 10,693 | 6,501 |
| 1987-1997 | 201,402 | 112,111 | 13.94% | 86,224 | 11,677 | 6,564 |
| 1988-1998 | 174,126 | 99,667 | 12.34% | 81,483 | 10,665 | 6,222 |
| 1989-1999 | 160,393 | 89,789 | 11.30% | 77,207 | 9,623 | 5,606 |
| 1990-2000 | 181,412 | 118,564 | 13.49% | 90,389 | 10,645 | 6,709 |
| 1991-2001 | 143,849 | 103,334 | 10.74% | 79,529 | 8,943 | 6,129 |
| 1992-2002 | 127,791 | 107,231 | 9.87% | 79,094 | 8,071 | 6,482 |
| 1993-2003 | 139,010 | 95,332 | 9.89% | 71,854 | 7,300 | 5,996 |
| 1994-2004 | 160,307 | 114,727 | 11.63% | 77,957 | 8,875 | 6,401 |
| 1995-2005 | 142,538 | 103,875 | 10.01% | 70,713 | 8,343 | 6,183 |
| 1996-2006 | 142,922 | 94,554 | 9.66% | 66,951 | 8,212 | 5,972 |
| 1997-June 2007 | 133,884 | 87,153 | 8.90% | 59,952 | 4,039* | 5,504 |
| 1998-June 2007 | 137,667 | 89,616 | 9.78% | 55,521 | 4,153* | 5,660 |
| 1999-June 2007 | 134,641 | 87,647 | 9.96% | 48,301 | 4,062* | 5,631 |
| 2000-June 2007 | 132,048 | 85,959 | 10.30% | 41,527 | 3,948* | 5,429 |
| 2001-June 2007 | 141,021 | 91,799 | 12.81% | 38,132 | 4,254* | 5,798 |
| 2002-June 2007 | 153,619 | 122,357 | 17.18% | 35,222 | 4,635* | 6,425 |

6% Citigroup Treasury/Gov't- Sponsored/Mortgage
7% Citigroup Non-U.S. World Gov't Bonds
6% Lehman Intermediate Aggregate Bonds
7% Lehman U.S. Corporate High Yield Index
5% Goldman Sachs Commodity Index
5% Mount Lucas Managed Futures
8% D J Wilshire Small Cap Value Index
10% Russell Mid-Cap Value index
15% D J Wilshire Large Cap Value Index
6% MSCI EM (Emerging Mkt.)
15% MSCI World Value Index
10% FTSE NAREIT REIT: ALL
*Six Month Distribution

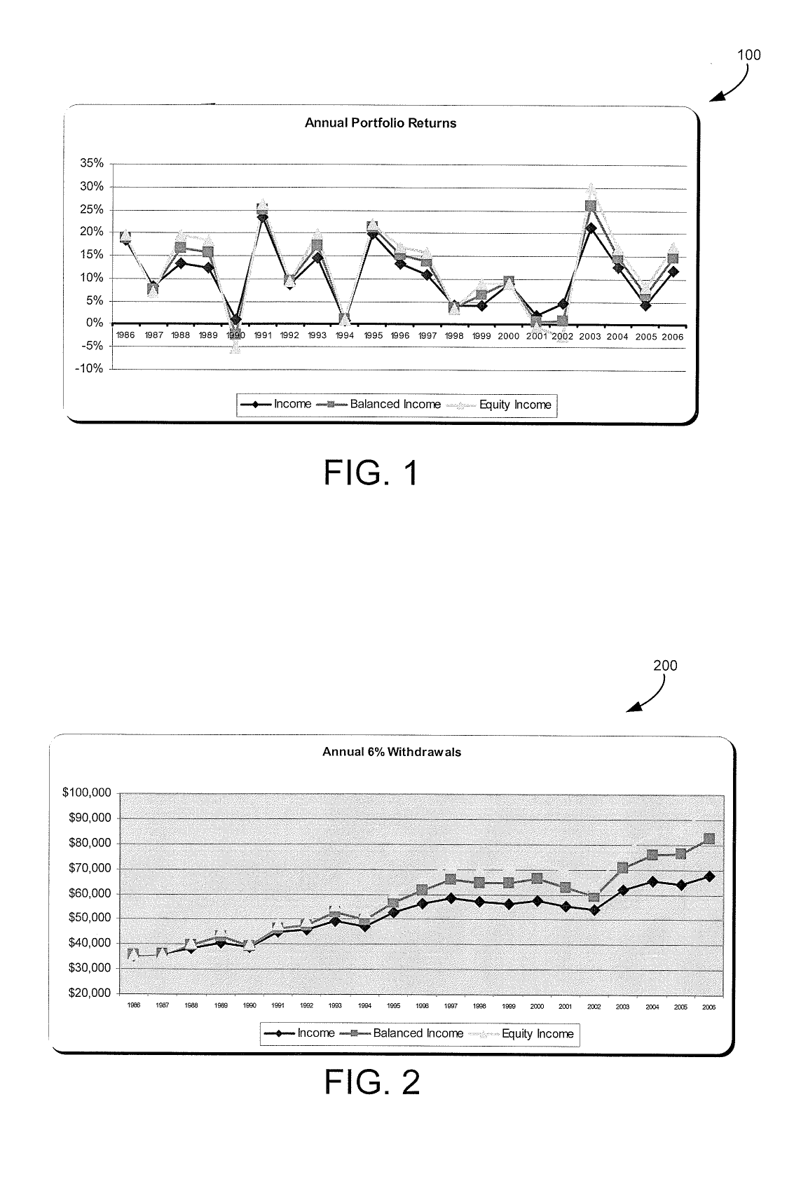

As shown in Table 6, based on historical data, the annual returns for each of the three portfolios (Income, Balanced Income, and Equity Income) fluctuated with market and other economic factors. A graphical representation of annual portfolio returns is depicted in FIG. 1.

However, as shown in Table 7, the annual amount of distributions steadily increased over the same period shown in Table 6. A graphical representation of the increase of portfolio returns over time is depicted in FIG. 2. Note that both Table 6 and FIG. 2 may also indicate that, because portfolio returns may steadily increase over time, distributions may also steadily increase to adjust for inflation and other economic factors.

TABLE 6
Annual Returns As A Percent Of The Portfolio's Asset Allocation

| | Income | Balanced Income | Equity Income |
|---|---|---|---|
| Year | Portfolio | Portfolio | Portfolio |
| 1986 | 18.3% | 18.8% | 19.6% |
| 1987 | 8.4% | 7.6% | 7.2% |
| 1988 | 13.3% | 16.7% | 19.5% |
| 1989 | 12.3% | 15.7% | 18.4% |
| 1990 | 1.2% | −2.3% | −5.2% |
| 1991 | 23.4% | 25.1% | 26.3% |
| 1992 | 8.8% | 9.5% | 9.6% |
| 1993 | 14.6% | 17.3% | 19.9% |
| 1994 | 0.9% | 1.0% | 1.1% |
| 1995 | 19.7% | 21.2% | 22.0% |
| 1996 | 13.2% | 15.4% | 16.9% |
| 1997 | 10.9% | 13.8% | 15.7% |
| 1998 | 4.2% | 3.8% | 3.5% |
| 1999 | 4.1% | 6.5% | 9.0% |
| 2000 | 9.1% | 9.4% | 9.0% |
| 2001 | 2.0% | 0.7% | −0.6% |
| 2002 | 4.6% | 0.8% | −2.5% |
| 2003 | 21.3% | 26.2% | 30.2% |
| 2004 | 12.5% | 14.8% | 16.6% |
| 2005 | 4.5% | 6.5% | 8.3% |
| 2006 | 11.9% | 14.8% | 17.3% |

TABLE 7
Annual Withdrawal
($500,000 starting balance, 6% of annual ending account value
withdrawal rate)

| | Income | Balanced Income | Equity Income |
|---|---|---|---|
| Year | Portfolio | Portfolio | Portfolio |
| 1986 | $35,503 | $35,644 | $35,876 |
| 1987 | $36,174 | $36,037 | $36,151 |
| 1988 | $38,517 | $39,516 | $40,604 |
| 1989 | $40,654 | $42,965 | $45,197 |
| 1990 | $38,658 | $39,441 | $40,255 |
| 1991 | $44,850 | $46,366 | $47,781 |
| 1992 | $45,875 | $47,717 | $49,221 |
| 1993 | $49,446 | $52,608 | $55,479 |
| 1994 | $46,898 | $49,929 | $52,725 |
| 1995 | $52,786 | $56,898 | $60,460 |
| 1996 | $56,185 | $61,698 | $66,438 |
| 1997 | $58,554 | $65,994 | $72,228 |
| 1998 | $57,373 | $64,410 | $70,250 |
| 1999 | $56,136 | $64,479 | $71,994 |
| 2000 | $57,568 | $66,306 | $73,783 |
| 2001 | $55,208 | $62,764 | $68,911 |
| 2002 | $54,301 | $59,484 | $63,164 |
| 2003 | $61,902 | $70,542 | $77,284 |
| 2004 | $65,490 | $76,155 | $84,703 |
| 2005 | $64,345 | $76,274 | $86,221 |
| 2006 | $67,666 | $82,314 | $95,070 |
| Balance | $1,127,768 | $1,371,898 | $1,584,493 |

Table 8 depicts a number of performance metrics for a plurality of strategic models during a simulated distribution phase over a 21-year period (1/1/1986-12/31/2006). In Table 8, a worst case single-year draw-down is a measure of the percentage change in the ending portfolio value from the end of one year to the end of the next year after considering the annual withdrawal. This measure is dependent on the prior year. The frequency of one-year loss is determined by assessing the distribution of 21-year IRR's, thus, each IRR is independent. While there was a zero frequency of a one-year IRR of −10% or worse, there was one year in which the maximum portfolio draw-down was −10.9%.

TABLE 8
Portfolio Performance Metrics

| Withdrawal Portfolio | | 21-Year | Probability | | | Frequency of | Frequency of |
|---|---|---|---|---|---|---|---|
| Results | | Standard | of Recovery | Worst Case | Frequency of | a Two-Year | a Three-Year |
| ($500,000 starting balance, | 21-Year | Deviation | from a 10% | Single Year | a One-Year | Cumulative | Cumulative |
| withdraw rate of 6% of | IRR | of Annual | Loss Within | Portfolio | Loss of 10% | Loss of 10% | Loss of 10% |
| end of year account | (%) | Returns | 3 Years | Draw-Down | or worse | or worse | or worse |
| balance) | 1986-2006 | (%) | (%) | (%)^{a} | (%)^{b} | (%) | (%) |
| Income Portfolio | 10.72 | 6.64 | 84.2 | −5.1 | 0 | 0 | 0 |
| Balanced Income | 11.64 | 8.16 | 89.5 | −8.2 | 0 | 0 | 0 |
| Portfolio | | | | | | | |
| Equity Income | 12.36 | 9.62 | 89.5 | −10.9 | 0 | 0 | 0 |
| Portfolio | | | | | | | |

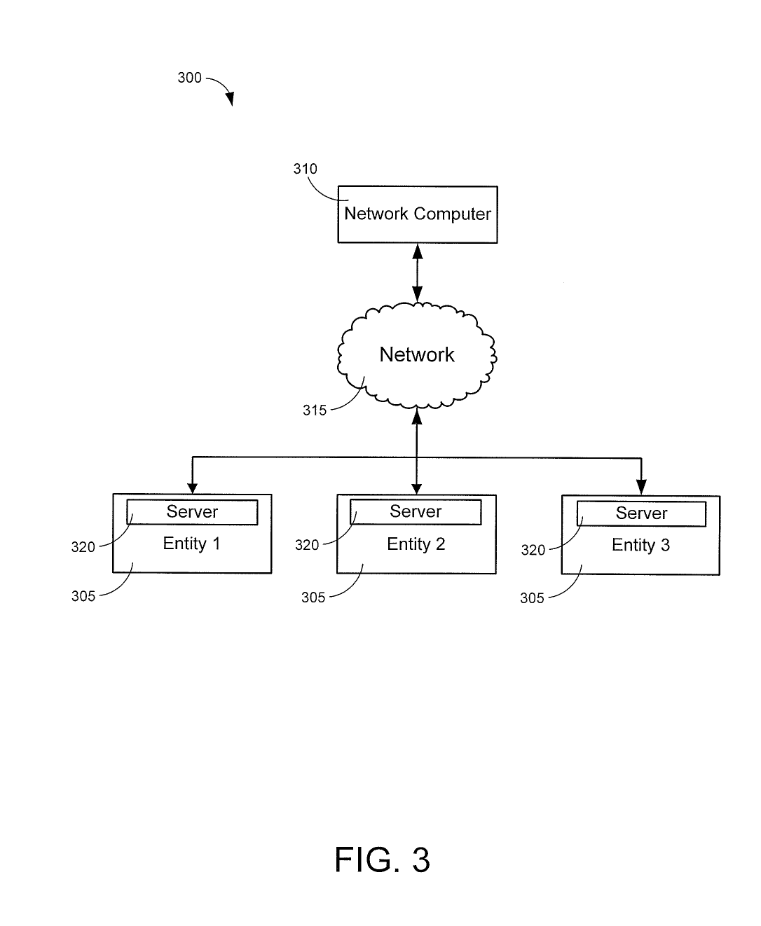

A method for generating retirement income by employing a Defined Income Fund may be implemented on a computer or within a network computer system. FIG. 3 illustrates an embodiment of a data network 300 including a first group of facilities or entities 305 operatively coupled to a network computer 310 via a network 315. The entities 305 may be physically co-located or geographically disparate. The plurality of entities 305 may be located, by way of example rather than limitation, in separate geographic locations from each other, in different areas of the same city, or in different states. Generally, the entities 305 may represent any of the different types of entities that may be involved in a creating and administering a Defined Income Fund. For example, the entities 305 may represent investors, financial advisors, investment companies, and financial institutions (e.g., banks, building societies, credit unions, stock brokerages, asset management firms). Any of the entities 305 may also be an intermediary between an investor, a financial advisor, and any of the other entities 305 described above.

The network 315 may be provided using a wide variety of techniques that are well known to those skilled in the art for the transfer of electronic data. For example, the network 315 may comprise dedicated access lines, plain ordinary telephone lines, satellite links, combinations of these, etc. Additionally, the network 315 may include a plurality of network computers or server computers (not shown), each of which may be operatively interconnected in a known manner. Where the network 315 comprises the Internet, data communication may take place over the network 315 via an Internet communication protocol.

The network computer 310 may be a personal computer or a server computer of the type commonly employed in networking solutions. The network computer 310 may be used by an entity 305 to accumulate, analyze, and download financial and investor data, or may be used to direct an investor or financial advisor to implement or facilitate the implementation of a Defined Income Fund. For example, the network computer 310 may periodically receive data from each of the entities 305 indicative of information pertaining to investor information or preferences, investment fund information, financial advisor data, financial institution data, etc. An investor, financial advisor, or other entity may use the network computer 310 to access and view information served from other network computers or servers 320 at the entities 305. For example, as a client/server model, the entities 305 may include one or more servers 320 that may be utilized to store any of the information described herein and to serve the information to a network computer 310 acting as the client.

In one embodiment, the network computer 310 or any of the entities 305 includes an interface to a financial modeling and analysis system and a financial records management system at an entity 305. For example, the network computer 310 may be connected to a financial modeling and analysis system and any suitable financial records management system, or any other type of distributed system that may be used to implement a Defined Income Fund. From a network computer 310, an investor, financial advisor, or other entity 305 may log into a financial records system that is communicatively coupled to a server 320 within an entity 305.

Although the data network 300 is shown to include one network computer 310 and three entities 305, it should be understood that different numbers of computers and entities may be utilized. For example, the network 300 may include a plurality of network computers 310 and dozens of entities 305, all of which may be interconnected via the network 315. According to the disclosed example, this configuration may provide several advantages, such as, for example, enabling nearly real time uploads and downloads of information as well as periodic uploads and downloads of information. This provides for a primary backup of all the information generated in the process of implementing a Defined Income Fund.

The computer 310 may be connected to a network, including local area networks (LANs), wide area networks (WANs), portions of the Internet such as a private Internet, a secure Internet, a value-added network, or a virtual private network. Suitable network computers 310 may also include personal computers, laptops, workstations, disconnectable mobile computers, mainframes, information appliances, personal digital assistants, and other handheld and/or embedded processing systems. The signal lines that support communications links to a computer 310 may include twisted pair, coaxial, or optical fiber cables, telephone lines, satellites, microwave relays, modulated AC power lines, and other data transmission “wires” known to those of skill in the art. Further, signals may be transferred wirelessly through a wireless network or wireless LAN (WLAN) using any suitable wireless transmission protocol, such as the IEEE series of 802.x standards. Although particular individual and network computer systems and components are shown, those of skill in the art will appreciate that the present invention also works with a variety of other networks and computers.

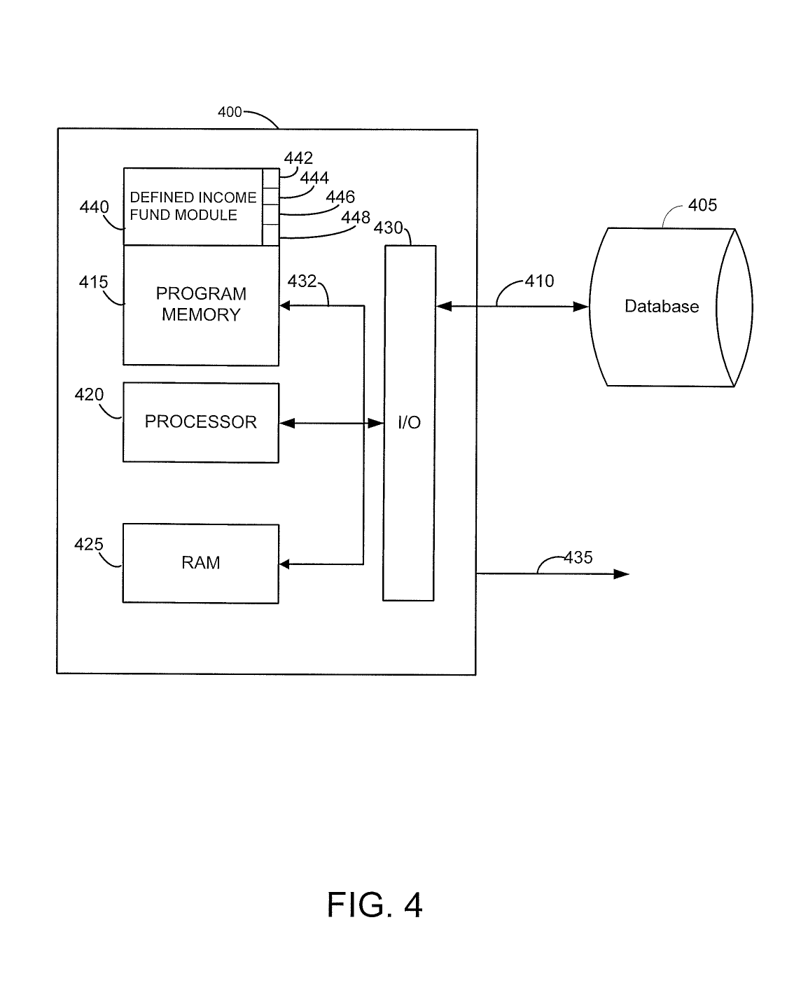

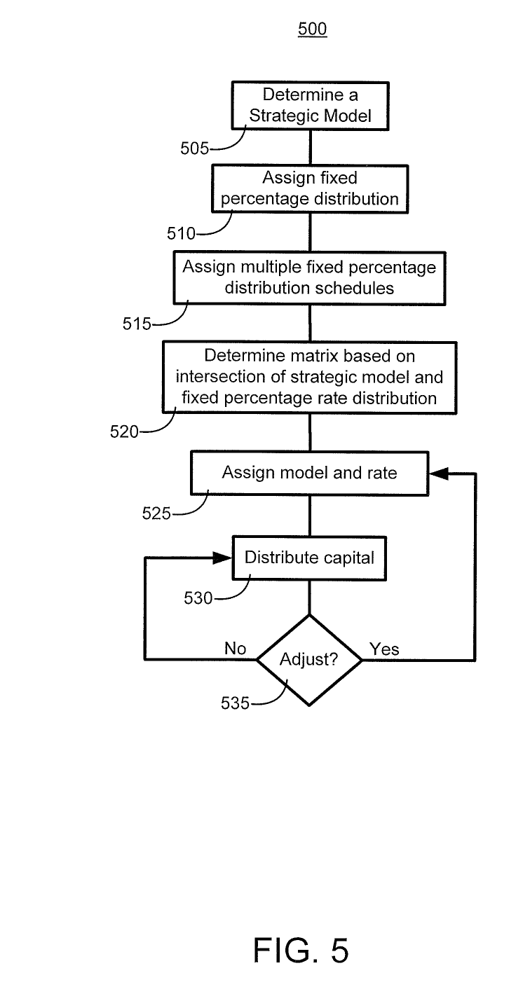

FIG. 4 is a schematic diagram of one possible embodiment of the network computer 310 shown in FIG. 3. The network computer 310 may have a controller 400 that is operatively connected to a database 405 via a link 410. It should be noted that, while not shown, additional databases may be linked to the controller 400 in a known manner. The controller 400 may include a program memory 415, a processor 420 (may be called a microcontroller or a microprocessor) for executing computer executable instructions, a random-access memory (RAM) 425 for temporarily storing data related to the computer executable instructions, and an input/output (I/O) circuit 430 for accepting and communicating the computer executable instructions, data for producing results with the computer executable instructions that are executed on the processor 420, and the results of any executed computer executable instructions. In one embodiment, the program memory 415 includes a Define Income Fund module 440 to implement one or more methods for generating retirement income by employing a Defined Income Fund, as described below in relation to FIG. 5. In another embodiment (not shown) the Define Income Fund module 440 may be a separately-implemented IC. The Define Income Fund module may also include a plurality of modules to implement one or more methods, for example, a strategic model module 442, a fixed percentage rate distribution module 444, a multiple fixed percentage rate distribution assignment module 446, and a matrix module 448. The Defined Income Fund module 440, and the plurality of modules 442, 444, 446, and 448 are discussed below in relation to FIG. 5. Of course, many other implementations of the Define Income Fund module 440 are possible.

The program memory 415, processor 420, and RAM may be interconnected via an address/data bus 432. It should be appreciated that although only one processor 420 is shown, the controller 400 may include multiple processors 420. Similarly, the memory of the controller 400 may include multiple RAMs 425 and multiple program memories 415. Although the I/O circuit 430 is shown as a single block, the I/O circuit 430 may include a number of different types of I/O circuits. The RAM(s) 425 and program memories 415 may be implemented as semiconductor memories, magnetically readable memories, and/or optically readable memories, for example. The controller 400 may also be operatively connected to the network 315 (FIG. 3) via a link 435.

The methods illustrated in the figures and described herein may be implemented as computer-executable instructions on a variety network computers 310, servers 320, other network devices using a variety of wired and wireless networks and connections, or within a Defined Income Fund module 440. Further, any action associated with the blocks described below and illustrated in FIG. 5 may be performed in any order, or at any time during the method 500 execution. With reference to FIGS. 3-6, a method 500 for generating retirement income by automatically adjusting retirement income for an economic factor, providing a plurality of distribution options for the retirement account, and determining a personal risk tolerance for the investor in a Defined Income Fund is discussed and described.

With reference to FIG. 5, a method 500 for generating retirement income using a Defined Income Fund is described. At block 505, the method 500 may determine one or more strategic models. As discussed above, a strategic model may include a plurality of investment vehicles. In one embodiment, the investment vehicles may be investment funds that are selected from a variety of asset classes and may include individual actively managed portfolios, fund of funds, and index-based ETF portfolios. As previously discussed, each portfolio's return and volatility may also be determined using Modern Portfolio Theory concepts by measuring a portfolio's diversification, correlation, and standard deviation to determine a measure of return and volatility. For example, each strategic model may include assets that are diversified according to any number of factors including asset class, type, and market, where portfolio variance, and hence volatility, is perfectly uncorrelated or inversely correlated (i.e., all assets within the portfolio have a correlation between 0 and −1). The strategic models may include an income model with a total return target of 6-8% and a volatility target of 4-6%, a balanced income model with a total return target of 8-10% and a volatility target of 6-8%, and an equity income model with a total return target of 10-12% and a volatility target of 8-10%. In another embodiment, a custom income model includes virtually any combination of assets that meets an investor's long-term income goals within return and volatility targets. Each strategic model may also be offered on a variety of bases, for example, a tax-advantaged model and a non-tax-advantaged model, and may be based on current or forecasted market conditions. Of course, the method 500 may determine many other types of strategic models with varying return, volatility, and other values.

In one embodiment, the method 500 may determine a strategic model using a network computer 310 with the strategic model module 442 of the Defined Income Fund module 440. For example, the strategic model module 442 may access or determine a plurality of Modern Portfolio Theory variables (e.g., diversification, correlation, standard deviation, etc.) from a database 405 or program memory 415. The strategic model module 442 may send commands to a processor 420 to determine several factors, including the portfolio return and the portfolio volatility. Of course, the method 500 may employ many other actions to determine a strategic model using or not using the strategic model module 442 or the network computer 310.

At block 510, the method 500 may assign a fixed percentage rate distribution to each strategic model determined at block 505. As previously discussed, the fixed percentage rate distribution may be fixed by prospectus and allow the distribution to fluctuate according to the value of the fund and, thus, according to market activity. The fixed percentage rate distribution may represent an amount calculated from the market value of the assets in a strategic model, as determined at block 505, to be paid to the investor periodically (e.g., annually, quarterly, monthly, etc.). Additionally, the method 500 may assign a supplemental annual distribution to each strategic model to ensure compliance with the 1940 rules.

In one embodiment, the method 500 may assign a fixed percentage rate distribution to each strategic model determined at block 505 using a network computer 310 with the fixed percentage rate distribution module 432. For example, the fixed percentage rate distribution module 432 may access historical market data from one or more sources (e.g., from a database 405 or program memory 415). The historical data may include information regarding the assets of a strategic model (e.g., asset valuation data, performance data, average periodic return, statistical data, etc.). The fixed percentage rate distribution module may send commands to a processor 420 or other module of a network computer 310, to determine a fixed percentage rate distribution to assign to each strategic model. Of course, the method 500 may employ many other actions to assign a fixed percentage rate distribution to each strategic model.

At block 515, the method 500 may assign multiple fixed percentage rate distributions to each strategic model determined at block 505. Before assigning the multiple rates, the method 500 may determine if the strategic model includes a sufficiently large number of investors to be able to assign multiple fixed percentage rate distributions. If the strategic portfolio includes enough investors, then the method may assign multiple fixed percentage rate distributions. For example, one strategic model may include distributions of 4%, 5%, and 6%. Of course, many other possible fixed percentage rate distributions may be assigned to a single strategic model.

In one embodiment, the method 500 may assign multiple fixed percentage rate distributions to each strategic model determined at block 505 using a network computer 310 with the multiple fixed percentage rate distributions module 444. For example, the multiple fixed percentage rate distributions module 444 may access statistical information about the model or each asset of the model from one or more sources (e.g., from a database 405 or program memory 415). The module 444 may then determine if multiple fixed percentage rate distributions are possible as well as the rate amount. The multiple fixed percentage rate distributions module 444 may send commands to a processor 420 or other module of a network computer 310, to determine multiple fixed percentage rate distributions to assign to each strategic model. Of course, the method 500 may employ many other actions to assign multiple fixed percentage rate distributions to each strategic model.

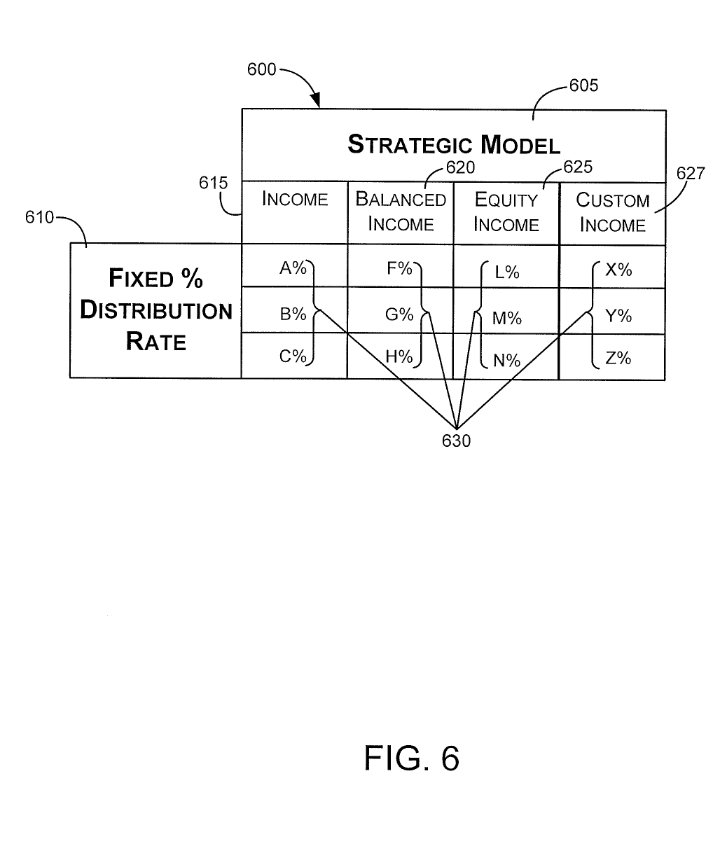

At block 520, the method 500 may determine a Defined Income Fund Matrix 600 (FIG. 6) from the one or more strategic models 605 determined at block 505 and the fixed percentage rate distribution schedules 610 assigned at block 510 and 515. In one embodiment, the intersection of the income 615, balanced income 620, the equity income 625, or the custom income 627 strategic model determined at block 505 and one of the multiple fixed percentage rate distributions 630 assigned at blocks 510 and 515 may represent an investor's desired payout within his or her personal risk tolerances. The fixed percentage rate distributions 630 within the Matrix 600 may be any rational value as determined by the Modern Portfolio Theory concepts discussed above and may be the same or different from the rates determined for each strategic model 605. For example, a risk-tolerant investor may choose an equity income strategic model 625 with a total return target of 10-12% and a volatility target of 8-10% over an income strategic model 615 with a total return target of 6-8% and a volatility target of 4-6%. The same investor may then choose a fixed percentage rate distribution 630 at an intersection of the chosen model 605 and rate 610. The model 605/rate 610 pair may be representation of a Defined Income Fund.

In one embodiment, the method 500 may determine the Defined Income Fund Matrix 600 using a network computer 310 with the matrix module 448. For example, the matrix module 448 may access statistical information about each model 605 or each fixed percentage rate 630 as determined at blocks 510 or 515. The matrix module 448 may match each fixed percentage rate 630 with a corresponding strategic model 615, 620, 625, and 627 and arrange the rates 630 and the models 615, 620, and 625 into a Defined Income Fund Matrix 600. The Matrix 600 may then be used by an investor, financial advisor, or other entity 305 to facilitate selection of a model 605 and rate 610 that suits one or more investors. Of course, the method 500 may employ many other actions to determine the Matrix 600.

At block 525, the method 500 may assign one or more of the model 605/rate 610 pairs (Defined Income Funds) from the Defined Income Fund Matrix 600 to one or more of an account, an investor, or other entity 305. In one embodiment, an investor may use an online account to select a model 605 and rate 610. For example, using a sequence of GET and POST commands at a network computer 310, the investor may, according to his or her personal risk tolerance, select one or more Defined Income Fund. In another embodiment, a financial advisor or other entity 305 may select the Defined Income Fund for the investor. The investor or other entity 305 may also associate an amount of money or other capital with the selection within an account that is assigned to the investor or other entity 305. Of course, many other methods exist to assign a Defined Income Fund to an investor.

At block 530, the method 500 may distribute an amount of money or other capital associated with the Defined Income Fund to the investor or other entity 305. The amount of payout may be determined according to the model 605 and rate 610 chosen by the investor. As previously described, in one embodiment, a Defined Income Fund may collect income from its equity and debt investments in the form of interest payments, dividends, rents, royalties, premiums, short term capital gains, long term capital gain and return of capital. Distributions of income may then be made from a percentage of Per Share Net Asset Value (NAV) on a quarterly schedule. For example, a Defined Income Fund with a 4% annual distribution may distribute 1% NAV quarterly, a Defined Income Fund with a 5% annual distribution may distribute 1.25% NAV quarterly, and a Defined Income Fund with a 6% annual distribution may distribute 1.5% NAV quarterly. A supplemental annual distribution may be established to ensure compliance with the 1940 rules. Distributions of capital may be made to an account associated with the investor or other entity 305, or may be sent to the investor in a negotiable instrument or any other form of value to the investor. Of course, many other distributions are possible depending on the chosen model 605, rate 610, and investor preferences.

At block 535, the method 500 may evaluate the distributions of block 530 to determine if either or both of a model 605 or rate 610 of the Defined Income Fund chosen at block 525 should be adjusted. For example, an investor or other entity 305 may determine that the distributions of block 530 are too low or too high and may, by returning to block 525, select one or more of a second model 605 and/or rate 610. Alternatively, the investor or other entity 305 may invest additional capital into the Defined Income Fund, or may choose a different rate 610 associated with the previously-chosen fund. If, however, the investor or other entity 305 determines that the distributions of block 530 do not need to be adjusted, the method 500 may return to block 530 and continue to distribute capital on a periodic basis. Of course, many other reasons and methods for adjusting the distributions of the Defined Income Fund may also be determined.

The Defined Income Fund and method described above may provide an investor with a lifetime of stable retirement income. Results of a study published in the July 2005 issue of Quantitative Analysis of Investor Behavior revealed that although the average S&P 500 stock fund delivered an annual return of 12.3% during the twenty year period of 1985-2004 the average stock fund investor only earned 3.7%. Less known and perhaps more damaging (especially, if the current retirement income model recommendations of 60%-80% participation in bonds persists) are the findings of a similar study by Dalbar, Inc. (QAIB, 2006. Advisor Edition). This study, covering the twenty year period from 1986 to 2005, revealed that although the return on the Long-Term Government Bond Index was 9.7% per year and inflation averaged 3.0% per year, the typical portfolio averaged a return of only 1.8% per year. This data suggests that the correlation of investor returns to investment fund returns is inversely proportional to the level of volatility inherent in the funds. As investors chase returns, the greater the volatility of a fund, the less likely that investors will earn the returns of the fund. Thus, the Defined Income Fund may present a low volatility asset allocation strategy for retirement income

The investment fund industry has yet to produce a long duration retirement income product. This is a void that cannot and will not persist. The size and diversity of the retirement income market suggests that a one size fits all approach will be insufficient. The complexity of the task suggests that any solution will be built on the most stable foundation of investment theory, risk analysis and disbursement, and institutionalized professional implementation and execution. The Defined Income Fund may provide an investor friendly, rules-based distribution platform upon which to integrate all the above components into a market disruptive retirement income offering.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed:

1. A method for automatically adjusting retirement income for an economic factor comprising:
determining a strategic model including a total return target and one or more investment funds;
assigning a fixed percentage rate distribution to the strategic model, wherein the fixed percentage rate distribution is lower than the total return target for a substantial portion of a period of time; and
paying a distribution on the strategic model at an end of the period of time, wherein a value of the distribution includes income from the one or more investment funds at the fixed percentage rate distribution.

2. The method of claim 1, wherein the strategic model includes one or more Modern Portfolio Theory factors.

3. The method of claim 2, wherein the one or more Modern Portfolio Theory factors includes one or more of a measure of diversification of the strategic model, a measure of correlation of the one or more investment funds of the strategic model, and a measure of standard deviation for a return for each of the one or more investment funds.

4. The method of claim 1, wherein the strategic model includes a volatility measure, the volatility measure comprising a standard deviation from a total return target for the strategic model.

5. The method of claim 1, further comprising assigning an amount of investor capital to the strategic model for the period of time.

6. The method of claim 1, wherein the distribution includes one or more of an interest payment, a dividend, a rent, a royalty, a premium, a short term capital gain, a long term capital gain, and a return of capital.

7. A method for providing a plurality of distribution options for a retirement account comprising:
determining a strategic model including a total return target and one or more investment funds;
assigning a plurality of fixed percentage rate distributions to the strategic model,
wherein each of the plurality of fixed percentage rate distributions has a unique percentage value;
assigning a plurality of investors to the strategic model;
determining an average fixed percentage rate distribution for the plurality of investors; and
paying a distribution on the strategic model to each of the plurality of investors at an end of a period of time,
wherein a value of the distribution to each of the plurality of investors includes income from the one or more investment funds at one of the plurality of fixed percentage rate distributions that is assigned to the strategic model, and
wherein the average fixed percentage rate distribution of the plurality of investors is lower than the total return target for a substantial portion of the period of time.

8. The method of claim 7, wherein the strategic model includes one or more Modern Portfolio Theory factors, wherein the one or more Modern Portfolio Theory factors includes one or more of a measure of diversification of the strategic model, a measure of correlation of the one or more investment funds of the strategic model, and a measure of standard deviation for a return for each of the one or more investment funds.

9. The method of claim 7, wherein the strategic model includes a volatility measure, the volatility measure comprising a standard deviation from a total return target for the strategic model.

10. The method of claim 7, wherein the distribution includes one or more of an interest payment, a dividend, a rent, a royalty, a premium, a short term capital gain, a long term capital gain, and a return of capital.

11. A method of determining a personal risk tolerance for an investor in a Defined Income Fund comprising:
determining a plurality of strategic models, each strategic model including a total return target, a measure of volatility, and one or more investment funds;
assigning a plurality of fixed percentage rate distributions to each strategic model;
determining a defined income matrix including a first axis and a second axis,
wherein the first axis includes the plurality of strategic models and the second axis includes the plurality of fixed percentage distributions, and
wherein an intersection of the first axis and the second axis is a Defined Income Fund representing the personal risk tolerance for the investor.

12. The method of claim 11, wherein the strategic model includes one or more Modern Portfolio Theory factors, wherein the one or more Modern Portfolio Theory factors includes one or more of a measure of diversification of the strategic model, a measure of correlation of the one or more investment funds of the strategic model, and a measure of standard deviation for a return for each of the one or more investment funds.

13. The method of claim 11, wherein the strategic model includes a volatility measure, the volatility measure comprising a standard deviation from a total return target for the strategic model.

14. The method of claim 11, wherein the plurality of strategic models includes one or more of an income model, a balanced income model, and an equity income model.

15. The method of claim 14, wherein, for the income model, a value of the total return target does not exceed 8 percent and a value of the measure of volatility does not exceed 6 percent.

16. The method of claim 14, wherein, for the balanced income model, a value of the total return target is in a range from 8 to 10 percent and a value of the measure of volatility is in a range from 6 to 8 percent.

17. The method of claim 14, wherein, for the equity income model, a value of the total return target is in a range from 10 to 12 percent and a value of the measure of volatility is in a range from 8 to 10 percent

18. A method for generating retirement income comprising:
determining a strategic model including one or more investment funds;
assigning a fixed percentage rate distribution to the strategic model;
determining a matrix including a first axis and a second axis, wherein the first axis includes the strategic model and the second axis includes the fixed percentage distribution, and wherein an intersection of the first axis and the second axis is a Defined Income Fund;
assigning one or more Defined Income Funds to an account; and
paying a distribution to the account, wherein a value of the distribution includes income from the one or more Defined Income Funds assigned to the account at the fixed percentage rate distribution.

19. The method of claim 18, wherein the strategic model includes one or more Modern Portfolio Theory factors, wherein the one or more Modern Portfolio Theory factors includes one or more of a measure of diversification of the one or more investment funds of the strategic model, a measure of correlation of the one or more investment funds of the strategic model, and a measure of standard deviation for a return for each of the one or more investment funds.

20. The method of claim 18, wherein the strategic model includes one or more fixed percentage rate distributions.

21. The method of claim 18, wherein the strategic model includes one or more of equity and debt investments.

22. A computer readable medium including computer executable instructions to implement a method to generate retirement income for an investor, the method comprising:
determining a strategic model including one or more investment funds;
assigning a fixed percentage rate distribution to the strategic model;
determining a matrix including a first axis and a second axis, wherein the first axis includes the strategic model and the second axis includes the fixed percentage distribution, and wherein an intersection of the first axis and the second axis is a Defined Income Fund;
assigning one or more Defined Income Funds to an account; and
paying a distribution to the account, wherein a value of the distribution includes income from the one or more Defined Income Funds assigned to the account at the fixed percentage rate distribution that is assigned to the strategic model.

23. The method of claim 22, wherein the strategic model includes one or more Modern Portfolio Theory factors, wherein the one or more Modern Portfolio Theory factors includes one or more of a measure of diversification of the one or more investment funds of the strategic model, a measure of correlation of the one or more investment funds of the strategic model, and a measure of standard deviation for a return for each of the one or more investment funds.

24. A computer system with a Defined Income Fund module for generating retirement income comprising:
a computer including a first processor;
one or more data repositories operatively coupled to the computer;
the Defined Income Fund module operatively coupled to computer and a memory storing computer-executable instructions for executing a program, the program comprising:
a strategic model module for determining a plurality of strategic models, each strategic model including a total return target, a measure of volatility, and one or more investment funds;
a fixed percentage rate distribution module for assigning a fixed percentage rate distribution to each of the plurality of strategic models;
a multiple fixed percentage rate distributions module for assigning multiple fixed percentage rate distributions to each of the plurality of strategic models; and
a Defined Income Fund matrix module for determining a matrix including a first axis and a second axis, wherein the first axis includes the plurality of strategic models and the second axis includes the plurality of fixed percentage distributions.

25. The method of claim 24, wherein the strategic model includes one or more Modern Portfolio Theory factors, wherein the one or more Modern Portfolio Theory factors includes one or more of a measure of diversification of the one or more investment funds of the strategic model, a measure of correlation of the one or more investment funds of the strategic model, and a measure of standard deviation for a return for each of the one or more investment funds.
